(19) United States
(12) Patent Application Publication
(10) Pub. No.: US 2023/0299393 A1
(43) Pub. Date: Sep. 21, 2023

(54) ALL-SOLID-STATE BATTERY AND METHOD FOR MANUFACTURING ALL-SOLID-STATE BATTERY

(71) Applicant: HONDA MOTOR CO., LTD., Tokyo (JP)

(72) Inventors: Ryo Shimizu, Wako-shi (JP); Takuya Taniuchi, Wako-shi (JP)

(73) Assignee: HONDA MOTOR CO., LTD., Tokyo (JP)

(21) Appl. No.: 18/112,943

(22) Filed: Feb. 22, 2023

(30) Foreign Application Priority Data
Mar. 17, 2022 (JP) 2022-042367

(51) Int. Cl. H01M 50/14; H01M 10/052; H01M 10/058

(52) U.S. Cl. CPC H01M 50/14; H01M 10/052; H01M 10/058

(57) ABSTRACT

An all-solid-state battery, comprising: an electrode body in which a positive electrode layer, a solid electrolyte layer, and a negative electrode layer are stacked; and an exterior member that houses the electrode body. The exterior member includes a first region facing a stack surface of an outermost layer of the electrode body, and a second region formed between the first region and a central portion of the electrode body in a stacking direction of the electrode body, and the second region is provided with a displacement absorbing portion capable of absorbing displacement of the electrode body.

### CROSS-REFERENCE TO RELATED APPLICATION(S)

This application claims priority to and the benefit of Japanese Patent Application No. 2022-042367 filed on Mar. 17, 2022, the entire disclosure of which is incorporated herein by reference.

### BACKGROUND OF THE INVENTION

### Field of the Invention

The present invention relates to an all-solid-state battery and a method for manufacturing the all-solid-state battery.

### Description of the Related Art

In order to reduce CO₂ from the viewpoint of climate-related disasters, there is an increasing interest in electric vehicles, and the use of secondary batteries as in-vehicle applications has been studied. An all-solid-state battery in which a solid electrolyte is disposed between a positive electrode and a negative electrode is attracting attention because the all-solid-state battery has higher safety, a wider usable temperature range, and a shorter charging time than a conventional lithium secondary battery.

Japanese Patent Laid-Open No. 2019-140022 discloses a technology for binding an all-solid-state battery in a planar direction intersecting a stacking direction of an electrode layer and the like when the all-solid-state battery expands and contracts according to an applied voltage as a measure against expansion and contraction that may occur due to charging and discharging of the all-solid-state battery.

The thickness of an exterior member of the all-solid-state battery in the stacking direction (the thickness of a deep drawn portion) is determined in accordance with an expansion thickness at the time of full charge so as to prevent occurrence of cracks and the like due to stress of a welded portion of the exterior member when an electrode body of an electrode element sealed inside is expanded in volume.

When a material with large volume expansion (for example, Si, Li metal, or the like) is used, various types of stress act on the all-solid-state battery due to a change in surface properties of the exterior member at the time of preparation of the all-solid-state battery, and at the time of full discharge or full charge after sealing, and performance of the all-solid-state battery may be affected by action of the various types of stress.

In view of the above problems, the present invention provides an all-solid-state battery capable of absorbing displacement of an electrode body.

### SUMMARY OF THE INVENTION

According to one aspect of the present invention, there is provided an all-solid-state battery, comprising: an electrode body in which a positive electrode layer, a solid electrolyte layer, and a negative electrode layer are stacked; and an exterior member that houses the electrode body, wherein the exterior member includes a first region facing a stack surface of an outermost layer of the electrode body, and a second region formed between the first region and a central portion of the electrode body in a stacking direction of the electrode body, and the second region is provided with a displacement absorbing portion capable of absorbing displacement of the electrode body.

According to another aspect of the present invention, there is provided a method for manufacturing an all-solid-state battery, wherein the all-solid-state battery comprises: an electrode body in which a positive electrode layer, a solid electrolyte layer, and a negative electrode layer are stacked; and an exterior member that houses the electrode body, wherein the exterior member includes a first region facing a stack surface of an outermost layer of the electrode body, and a second region formed between the first region and a central portion of the electrode body in a stacking direction of the electrode body, the second region being provided with a displacement absorbing portion capable of absorbing displacement of the electrode body, the manufacturing method comprising forming a plurality of steps in the displacement absorbing portion by pressing a material of the exterior member.

### BRIEF DESCRIPTION OF THE DRAWINGS

FIG. 1A is a plan view of an all-solid-state battery according to an embodiment of the present invention;

FIG. 1B is a cross-sectional view taken along line A-A of FIG. 1A;

FIG. 2 is a chart describing an outline of a flow of a method for manufacturing the all-solid-state battery according to the embodiment;

FIG. 3 is a view schematically illustrating a process in steps of forming an exterior member;

FIGS. 4A and 4B are views illustrating a schematic shape of a jig used in a step of forming an exterior member;

FIG. 5 is an enlarged view of a portion B in FIG. 1A; and

FIG. 6 is a diagram illustrating a comparative example of a conventional example and the all-solid-state battery according to the embodiment.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

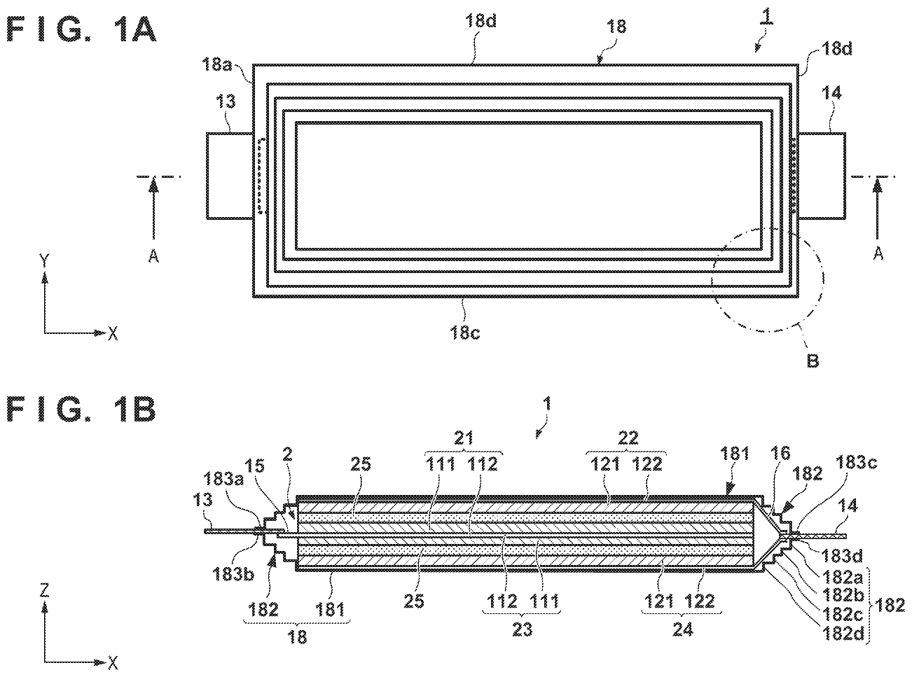

FIGS. 1A and 1B are views illustrating a configuration of an all-solid-state battery 1 according to an embodiment of the present invention. FIG. 1A is a plan view of the all-solid-state battery 1 according to an embodiment, and FIG. 1B is a cross-sectional view of the all-solid-state battery 1 taken along line A-A in FIG. 1A. In the coordinate system in the drawings, an X axis indicates a longitudinal direction of the all-solid-state battery 1 (an extending direction of a lead tab), a Y axis indicates a width direction of the all-solid-state battery 1 (an orthogonal direction orthogonal to the extending direction of lead tabs), and a Z axis indicates a thickness direction of the all-solid-state battery 1 (a stacking direction of the electrode body 2). FIG. 1A is a view of the all-solid-state battery 1 in an XY plane, and FIG. 1B is a view of the all-solid-state battery 1 in an XZ plane.

The all-solid-state battery 1 includes an electrode body 2 (also referred to as a stacked body in the present embodiment) that is a power storage device in which a positive electrode layer, a solid electrolyte layer and a negative electrode layer are stacked, an exterior member 18 that seals a periphery of the accommodated electrode body 2, lead tabs 13 and 14, and current collecting tabs 15 and 16.

The electrode body 2 illustrated in FIG. 1B has a structure in which a positive electrode layer and a negative electrode layer each include two layers. The positive electrode layer includes two layers of positive electrode layers 21 and 23, and the negative electrode layer includes two layers of negative electrode layers 22 and 24. A solid electrolyte layer 25 is provided between the positive electrode layer 21 and the negative electrode layer 22. Similarly, a solid electrolyte layer 25 is provided between the positive electrode layer 23 and the negative electrode layer 24. Note that the positive electrode layer and the negative electrode layer may be a single phase (one phase) or may be constituted by a plurality of layers. When a plurality of positive electrode layers and a plurality of negative electrode layers are provided, as illustrated in FIG. 1B, a solid electrolyte layer is provided between each positive electrode layer and each negative electrode layer. In the example of FIG. 1B, the structure in which the positive electrode layer and the negative electrode layer each have two layers is exemplified, but the present invention is not limited to this example, and the positive electrode layer and the negative electrode layer may each have three or more layers.

The positive electrode layers 21 and 23 each have a positive electrode active material layer 111 and a positive electrode current collector 112. The positive electrode current collector 112 is common to the two positive electrode layers 21 and 23. The positive electrode current collector 112 is disposed at the center in a thickness direction (Z direction) of the electrode body 2, and the positive electrode active material layer 111 of the positive electrode layer 21 and the positive electrode active material layer 111 of the positive electrode layer 23 are stacked on an upper surface side and a lower surface side of the positive electrode current collector 112, respectively.

The negative electrode layer 22 is disposed (stacked) on an upper surface side in the thickness direction (Z direction) of the electrode body 2 with respect to the positive electrode layer 21, and the negative electrode layer 24 is disposed (stacked) on a lower surface side in the thickness direction (Z direction) of the electrode body 2 with respect to the positive electrode layer 23. The negative electrode layers 22 and 24 are stacked so as to sandwich the positive electrode layers 21 and 23. The negative electrode layers 22 and 24 each have a negative electrode active material layer 121 and a negative electrode current collector 122. The two negative electrode current collectors 122 are each formed in a layer form at an outermost layer of the electrode body 2. Note that the configurations of the positive electrode layer and the negative electrode layer are not limited to the stacking order as illustrated in FIG. 1B, and a configuration in which two positive electrode layers are stacked so as to sandwich two negative electrode layers may be employed.

Examples of active materials constituting the positive electrode active material layer 111 include NCM based materials (ternary active materials) in which cobalt, nickel, and manganese are mixed, for example, lithium cobaltate, lithium nickelate, lithium manganate, and the like.

Examples of active materials constituting the negative electrode active material layer 121 include a lithium-based material, a silicon-based material, and the like. Other examples of the materials constituting the negative electrode active material layer 121 include carbon materials such as graphite, soft carbon, and hard carbon, tin-based materials, transition metal oxide-based materials (for example, lithium titanate: LTO), and the like.

The solid electrolyte layer 25 is formed by, for example, a solid electrolyte having ion conductivity, and examples of materials thereof include sulfide-based solid electrolyte materials, oxide-based solid electrolyte materials, nitride-based solid electrolyte materials, and halide-based solid electrolyte materials, and the like.

The positive electrode current collector 112 and the negative electrode current collector 122 are formed by, for example, a metal foil such as aluminum, copper, or SUS, a metal sheet, or a metal plate. The positive electrode active material layer 111, the negative electrode active material layer 121, and the solid electrolyte layer 25 may be formed by bonding particles of substances constituting them with an organic polymer compound-based binder. The positive electrode active material layer 111 or the negative electrode active material layer 121 may contain an electron conduction assistant such as carbon (particles, fibrous) or metal powder. In the positive electrode active material layer 111 or the negative electrode active material layer 121, a solid electrolyte powder may also be disposed for constructing an ion conductive path. The exterior member 18 is an accommodating body that accommodates the electrode body 2. The exterior member 18 is formed by folding one sheet-like material into two or bonding a plurality of sheet-like materials to each other. The material of the exterior member 18 is formed by, for example, covering the front and back surfaces of a metal layer with an insulating layer.

The exterior member 18 has a rectangular shape constituted by four sides 18a to 18d in plan view from the Z direction, and a peripheral edge portion of the exterior member 18 is sealed in a state where the electrode body 2 is accommodated. The peripheral edge portion of the exterior member 18 is sealed by bonding, welding, or the like of the material of the exterior member 18.

Of the four sides 18a to 18d of the exterior member 18, the strip-shaped lead tabs 13 and 14 are provided so as to cross the sides 18a and 18b facing each other, and the electrode body 2 is positioned between the lead tab 13 and the lead tab 14.

As illustrated in FIG. 1B, peripheral edge portions 183a and 183b of the exterior member 18 are sealed so as to sandwich the lead tab 13, and peripheral edge portions 183c and 183d of the exterior member 18 are sealed so as to sandwich the lead tab 14.

One end portion of the lead tab 13 is located outside the exterior member 18, and the other end portion is located inside the exterior member 18. The other end portion of the lead tab 13 is connected to the positive electrode current collector 112 via the current collecting tab 15 inside the exterior member 18, and the lead tab 13 forms a positive electrode tab. The lead tab 13 and the current collecting tab 15 are formed by, for example, a conductive metal sheet or metal plate.

One end portion of the lead tab 14 is located outside the exterior member 18, and the other end portion is located inside the exterior member 18. The other end portion of the lead tab 14 is connected to the negative electrode current collector 122 via the current collecting tab 16 inside the exterior member 18, and the lead tab 14 forms a negative electrode tab. The lead tab 14 and the current collecting tab 16 are formed by, for example, a conductive metal sheet or metal plate. The electrode body 2 can be charged or discharged by connecting the lead tabs 13 and 14 to a charger or an electric load.

In the embodiment of the present invention, the exterior member 18 has a flexible structure (displacement absorbing portion) capable of absorbing displacement of the electrode body 2 due to expansion and contraction of the electrode body 2. The exterior member 18 has a first region 181 facing a surface (stack surface of the outermost layer) of the electrode body 2 intersecting with a thickness direction (stacking direction) of the electrode body 2, and a second region 182 formed between the first region 181 and a central portion (for example, lead tabs 13 and 14 of FIGS. 1A and 1B) of the electrode body 2 in the stacking direction of the electrode body 2. The second region 182 is provided with a displacement absorbing portion capable of absorbing displacement. In the displacement absorbing portion, a plurality of steps 182a to 182d is formed in a side view of the exterior member 18. The displacement absorbed by the displacement absorbing portion includes at least one of displacement in the stacking direction (Z direction) of the electrode body 2, displacement in the longitudinal direction (X direction) of the electrode body 2, or displacement in the width direction (Y direction) of the electrode body 2. Here, the cross-sectional shape of the plurality of steps 182a to 182d may include irregularities formed on the surface of the exterior member 18 along the stacking direction (Z direction) of the electrode body 2. For example, the cross-sectional shape of the plurality of steps 182a to 182d may be a cross-sectional shape formed by combining straight lines in a stepwise shape at a predetermined angle, or may be a cross-sectional shape formed by combining an arc or a triangular waveform in a wave shape. In addition, the both cross-sectional shapes may be combined.

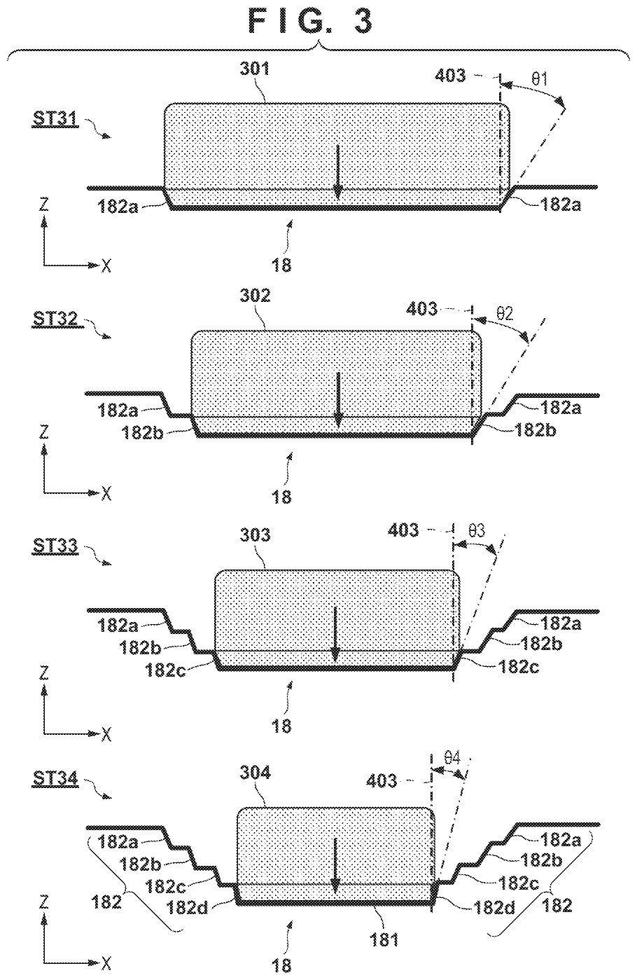

In FIG. 3 described below, the cross-sectional shape formed by combining straight lines in a stepwise manner at a predetermined angle (θ1 to θ4) between adjacent steps is exemplarily described, but the cross-sectional shape of the plurality of steps 182a to 182d of the present embodiment is not limited to this example. The cross-sectional shape of the plurality of steps 182a to 182d in FIG. 3 may be formed by a cross-sectional shape formed by combining an are having a predetermined curvature or a triangular waveform in a wave shape.

(Manufacturing Method)

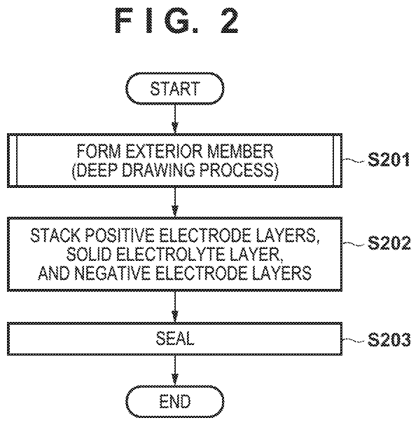

FIG. 2 is a chart describing an outline of a flow of a method for manufacturing the all-solid-state battery 1 according to the embodiment of the present invention. In step S201, the exterior member 18 is formed in advance by another flow. In step S202, the positive electrode layers 21 and 23, the solid electrolyte layer 25, and the negative electrode layers 22 and 24 described in FIGS. 1A and 1B are manufactured, and the manufactured electrode layers are stacked to manufacture the electrode body 2. Then, in step S203, the electrode body 2 is housed in the exterior member 18 formed in S201, and the periphery of the exterior member 18 is sealed. Note that a flowchart of FIG. 2 is exemplary, and step S201 and step S202 may be reversed.

FIG. 3 is a view schematically illustrating a process in steps of forming the exterior member 18 (deep drawing process) in step S201, and here, an example in which four steps are formed as a configuration of the displacement absorbing portion is illustrated (ST31 to ST34). Note that the number of steps is not limited to this example.

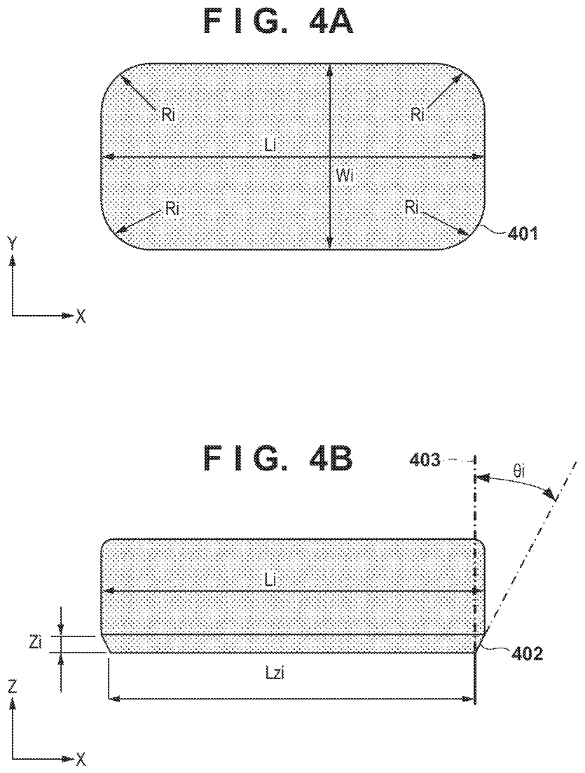

FIGS. 4A and 4B are views illustrating a schematic shape of a jig used in a step of forming the exterior member 18. FIG. 4A illustrates a schematic planar shape of the jig on the XY plane, and FIG. 4B illustrates a schematic side surface shape of the jig on the XZ plane. The planar shape of the jig has Li as a dimension in the X direction (longitudinal direction) and has Wi as a dimension in the Y direction (width direction). The four corners 401 have a radius Ri.

An inclined portion 402 forming a step is formed at a lower end portion of the jig. The inclined portion 402 has an inclination angle θi inclined with respect to a normal line of a surface (region surface) formed in the first region 181 which is a plane facing the stack surface of the electrode body 2. For example, as illustrated in FIGS. 4A and 4B, when a dimension of a lower end surface of the jig in the X direction (longitudinal direction) is Lzi and a depth of the inclined portion in the Z direction is Zi, the inclination angle can be obtained by θi=(Li−Lzi)/Zi. A similar inclined portion is also formed in the Y direction (width direction) of the lower end surface of the jig, and when a dimension of the lower end surface of the jig in the Y direction (width direction) is Wzi (not illustrated) and a depth of the inclined portion in the Z direction is Zi, the inclination angle can be obtained by θi=(Wi−Wzi)/Zi. The inclination angle θi of the inclined portion 402 is the same in the X direction (longitudinal direction) and the Y direction (width direction).

The inclined portion having the inclination angle θi is formed in four directions of the X direction (longitudinal direction) and the Y direction (width direction) of the jig, and when the material of the exterior member 18 is pressed by the deep drawing process by the jig, a step having the inclination angle θi is formed in four directions in the longitudinal direction and the width direction of the exterior member 18 in the side view in the XZ direction. In a plan view in the XY directions, comers having a radius Ri are formed at four corners where respective sides in the longitudinal direction and the width direction of the exterior member 18 intersect each other.

Although an example in which different jigs 301 to 304 are selectively used in each step of ST1 to ST4 is illustrated in FIG. 3, the present invention is not limited to the use of different jigs 301 to 304, and a device having one jig in which the shape of each jig 301 to 304 is formed in multiple stages may be used.

The inclined portions (402 in FIG. 4B) of the jigs 301 to 304 illustrated in FIG. 3 have different inclination angles θ1 to θ4. The relationship between the inclination angles θ1 to θ4 is such that θ2 is smaller than θ1 (θ2<θ1), θ3 is smaller than θ2 (θ3<θ2), and θ4 is smaller than θ3 (θ4<θ3).

The corners (401 in FIG. 4A) of the jigs 301 to 304 have different radii Ri. A radius of the jig 301 is R1, a radius of the jig 302 is R2, a radius of the jig 303 is R3, and a radius of the jig 304 is R4. Here, the relationship between the radii is such that R2 is smaller than R1 (R2<R1), R3 is smaller than R2 (R3<R2), and R4 is smaller than R3 (R4<R3).

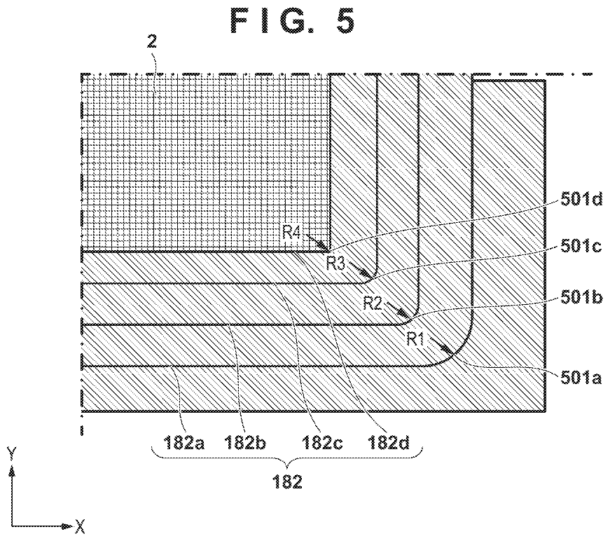

In ST31 of FIG. 3, the step 182a (first step) is formed by pressing a material of the exterior member 18 with the jig 301. Here, FIG. 5 is a view illustrating a state where a portion B in FIG. 1A is enlarged, and corners 501a to 501d having different radii R1 to R4 are formed at corners of the plurality of steps 182a to 182d in a plan view of the exterior member 18. In ST31, the corner 501a having the radius R1 is formed at the corner of the step 182a.

In ST32, the step 182b (second step) is formed by pressing the material of the exterior member 18 with the jig 302. Further, in ST32, the corner 501b having the radius R2 is formed at the corner of the step 182b.

In ST33, the step 182c (third step) is formed by pressing the material of the exterior member 18 with the jig 303. Further, in ST33, the corner 501c having the radius R3 is formed at the corner of the step 182c.

Then, in ST34, the step 182d (fourth step) is formed by pressing the material of the exterior member 18 with the jig 304. Further, in ST34, the corner 501d having the radius R4 is formed at the corner of the step 182d. The dimension Li in the X direction and the dimension Wi in the Y direction of the jig 304 are equal to the dimensions in the X direction and the Y direction of the electrode body 2, and the step 182d formed by the jig 304 is formed so as to be able to abut on the side surface of the electrode body 2.

As described above, in the step of forming the exterior member 18 (S201), the plurality of steps 182a to 182d is formed in the displacement absorbing portion of the second region 182 by pressing the material of the exterior member 18 multiple times using the jigs 301 to 304 or the like. Note that, in the example of FIG. 3, an example in which the plurality of steps 182a to 182d are formed using the jigs 301 to 304 or the like in ST31 to ST34 is described, but the formation of the steps is not limited to this example. For example, when the jigs 301 to 304 combined as one jig is used, the plurality of steps 182a to 182d can be formed in the displacement absorbing portion of the second region 182 by pressing the material of the exterior member 18 at least once.

Since the inclination angles of the inclined portions in the jigs 301 to 304 are different, the plurality of steps 182a to 182d formed in ST31 to ST34 are formed at different inclination angles θ1 to θ4 with respect to a normal line 403 of the surface formed in the first region 181. In addition, since the radii of the comers of the jigs 301 to 304 are different, the corners of the plurality of steps 182a to 182d formed in ST31 to ST34 are formed with different radii R1 to R4, respectively.

With respect to the inclination angle of each step in a side view, among the plurality of steps 182a to 182d, a step (for example, step 182b, 182c, or 182d) formed in a direction away from the central portion (for example, the lead tabs 13 and 14 of FIGS. 1A and 1B) in the stacking direction of the electrode body 2 is formed at an inclination angle smaller than the inclination angle θ1 of the step (for example, the step 182a) formed in the central portion.

Among the plurality of steps 182a to 182d, a step (for example, 182d) formed at a position close to the surface of the electrode body 2 (the stack surface of the outermost layer) is formed at an inclination angle (for example, substantially zero) at which the step can be brought into contact with the side surface of the electrode body 2. At least a part of the step 182d abuts on the side surface of the electrode body 2 housed in the exterior member 18.

With respect to the radius of each step in plan view, among the plurality of steps 182a to 182d, the radius of the corner of a step (for example, step 182b, 182c, or 182d) formed in the direction away from the central portion (for example, lead tabs 13 and 14 of FIGS. 1A and 1B) in the stacking direction of the electrode body 2 is formed with a radius (R2 to R4) smaller than the radius R1 of the corner of the step (for example, the step 182a) formed in the central portion.

Among the plurality of steps 182a to 182d, the radius of the corner of the step (for example, 182d) formed at a position close to the surface of the electrode body 2 (the stack surface of the outermost layer (122 in FIG. 1B)) is formed to be a radius (for example, approximately 90 degrees) which can be brought into contact with the side surface of the electrode body 2.

By forming the step 182d at the inclination angle (side view direction) and the radius (plan view direction) at which the step can be brought into contact with the side surface of the electrode body 2, the electrode body 2 is held by being brought into contact with the step 182d in a state where the electrode body 2 is housed in the exterior member 18, and it is possible to prevent a positional displacement of the electrode body 2 in the XY directions in the exterior member 18 due to vibration. Further, in a state where the electrode body 2 is housed in the exterior member 18, the surface of the electrode body 2 (the stack surface of the outermost layer (122 in FIG. 1B)) is brought into contact with a region surface which is formed in the first region 181 of the exterior member 18 and has a two-dimensional expansion. The region surface formed in the first region 181 is parallel to the stack surface of the outermost layer of the electrode body 2. With such a configuration, it is possible to prevent the positional displacement of the electrode body 2 in the Z direction in the exterior member 18 caused by vibration.

(Comparison between Conventional Example and Embodiment)

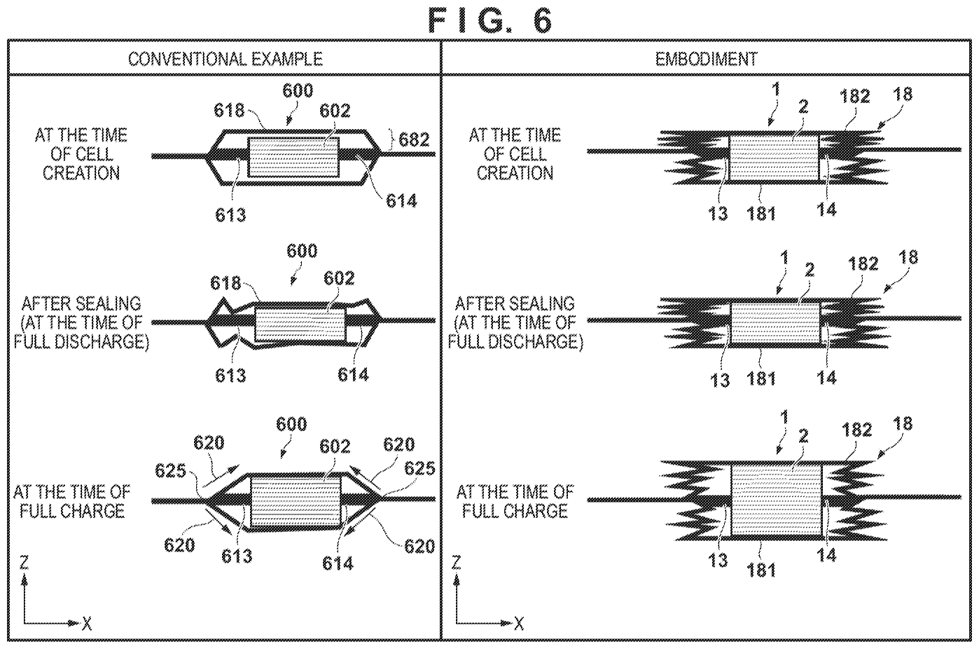

FIG. 6 is a diagram illustrating a comparative example of an all-solid-state battery 600 of a conventional example and the all-solid-state battery 1 according to the embodiment.

(At Time of Cell Creation)

At the time of cell creation in the conventional example, a deep drawn portion 682 is formed in the Z direction of an exterior member 618 so as to provide a predetermined gap (space) between an electrode body 602 and the exterior member 618 in consideration of expansion displacement of the electrode body 602 at the time of full charge. Thus, the electrode body 602 is configured to be supported only by lead tabs 613 and 614. Since the electrode body 602 cannot be brought into a floating state in the air, the lengths of the lead tabs 613 and 614 are increased to absorb the gap by the displacement of the lead tabs 613 and 614. With the configuration of the conventional example, it is necessary to form the lead tabs 613 and 614 longer for stress relaxation that prevents excessive stress from acting on the vicinity of the lead tabs 613 and 614, but in this case, the energy density decreases.

On the other hand, according to the configuration of the all-solid-state battery 1 of the embodiment, since the plurality of steps 182 (182a to 182d) of the displacement absorbing portion can absorb displacement of the electrode body 2 in the stacking direction, it is not necessary to provide a predetermined gap between the electrode body 2 and the exterior member 18. Thus, the electrode body 2 is held in a state of being brought into contact with the exterior member 18 (for example, 181 and 182d in FIG. 1B). Accordingly, the lead tabs 13, 14 and the electrode body 2 can be positioned at the center in the Z direction in a state where the stress acting on the lead tabs 13 and 14 is suppressed. Further, according to the configuration of the all-solid-state battery 1 of the embodiment, it is possible to suppress a decrease in energy density in the lead tabs 13 and 14 as may occur in the conventional example.

(After Sealing)

After sealing in the conventional example, since the inside of the cell is sealed in a vacuum state in which the pressure is reduced to a predetermined pressure, the surface of the exterior member 618 including the deep drawn portion 682 is deformed by the atmospheric pressure outside the cell. When vacuum-sealing is performed, atmospheric pressure acts on the deep drawn portion 682, so that wrinkle-like deformation may occur. When a material with large volume expansion (for example, Si or Li metal) is used for the electrode body 602, the depth of the deep drawn portion needs to be made deeper, and when the predetermined gap is made deeper, the deformation of the surface of the exterior member 618 becomes larger. In this case, the deformed exterior member 618 comes into contact with the electrode body 602, a pressing force due to the contact is applied to the electrode body 2, and thereby a positional displacement may occur at a stacking position of each electrode layer of the electrode body 602. Therefore, sealing must be performed by slow vacuuming. This may increase takt time of production and increase manufacturing costs.

On the other hand, with the configuration of the all-solid-state battery 1 of the embodiment, since the plurality of steps 182 (182a to 182d) of the displacement absorbing portion can absorb the displacement of the electrode body 2 in the stacking direction, even if the displacement is generated in the surface property of the exterior member 18 under the influence of the atmospheric pressure outside the cell, the plurality of steps 182 (182a to 182d) of the displacement absorbing portion is preferentially deformed to absorb the displacement earlier than the first region 181, so that the surface of the first region 181 in contact with the electrode body 2 is not deformed. Further, it is possible to suppress positional displacement that may occur at the stacking position of each electrode layer of the electrode body. Furthermore, as compared with the conventional example, the takt time of production can be shortened, and the manufacturing cost can be reduced.

(At Time of Full Charge)

In the conventional example, since the depth of the deep drawn portion 682 is set in accordance with the thickness of the electrode body 602 at the time of full charge, even if the electrode body 602 expands in the Z direction at the time of full charge, the influence of the stress acting on the exterior member 618 is small.

However, when expansion exceeding a predetermined maximum thickness occurs in the electrode body 602, tensile stress in a direction of an arrow 620 acts on the deep drawn portion 682 of the exterior member 618. This may affect the performance of the lead tabs 613 and 614 and a peripheral edge portion 625 (sealing portion).

On the other hand, with the configuration of the all-solid-state battery 1 of the embodiment, since the plurality of steps 182 (182a to 182d) of the displacement absorbing portion can absorb the displacement of the electrode body 2, even if the expansion of the electrode body 2 in the stacking direction occurs, the plurality of steps 182 (182a to 182d) of the displacement absorbing portion absorb the displacement earlier than the first region 181 following the expansion of the electrode body 2 in the Z direction. Therefore, the surface of the first region 181 in contact with the electrode body 2 is not deformed. In addition, since the generation of the tensile stress in the direction of the arrow 620 is also suppressed, the influence on the lead tabs 13 and 14 and the peripheral edge portions 183a to 183d (FIG. 1B) can be reduced as compared with the conventional example. In the configuration of the all-solid-state battery 1 of the embodiment, the thickness of the all-solid-state battery 1 at the time of cell creation is t1, and the thickness of the all-solid-state battery 1 after sealing (state of charge (SOC) 0% or less) is t2. The thickness of the all-solid-state battery 1 at the time of full charge (SOC 100%) is t3, and the thickness of the all-solid-state battery 1 at the time of full discharge (SOC 0%) is t4. In this case, the thickness relationship is t2≤t1<t4<t3. As described above, with the all-solid-state battery 1 of the present embodiment, even when expansion and contraction of the electrode body 2 in which the thickness changes (t2≤t1<t4<t3) occur, the plurality of steps 182 (182a to 182d) of the displacement absorbing portion follows the expansion and contraction of the electrode body 2 in the Z direction and absorbs the displacement earlier than the first region 181.

<Summary of Embodiments>

The above embodiment discloses at least the following all-solid-state battery and method for manufacturing an all-solid-state battery.

Configuration 1. An all-solid-state battery (1), comprises:
an electrode body (2) in which a positive electrode layer (21,23), a solid electrolyte layer (25), and a negative electrode layer (22,24) are stacked; and
an exterior member (18) that houses the electrode body, wherein
the exterior member (18) includes a first region (181) facing a stack surface of an outermost layer of the electrode body, and a second region (182) formed between the first region and a central portion of the electrode body in a stacking direction of the electrode body, and
the second region is provided with a displacement absorbing portion (182a-182d) capable of absorbing displacement of the electrode body.

According to this embodiment, it is possible to provide an all-solid-state battery in which, even when expansion and contraction of the electrode body (2) occur, the displacement absorbing portion is deformed following the displacement of the electrode body and absorbs the expansion and contraction, and thereby the displacement of the surface property of the exterior member and the displacement of the electrode body can be absorbed.

Configuration 2. A plurality of steps (182a-182d) are formed in the displacement absorbing portion.

According to this embodiment, even when expansion and contraction of the electrode body 2 occur, the plurality of steps (182a to 182d) is deformed following the displacement of the electrode body 2 and absorbs the expansion and contraction, and thereby the displacement of the surface property of the exterior member and the displacement of the electrode body can be absorbed.

Configuration 3. The plurality of steps (182a-182d) are formed at different inclination angles (θ1 to θ4) with respect to a normal line (403) of a surface formed in the first region.

Configuration 4. Among the plurality of steps (182a-182d), a step (182b-182d) formed in a direction away from a central portion in the stacking direction is formed at an inclination angle (θ2 to θ4) smaller than an inclination angle (θ1) of a step (182a) formed in the central portion.

Configuration 5. At least a part of a step (182d) formed at a position close to a surface of the electrode body among the plurality of steps (182a-182d) abuts on a side surface of the electrode body (2) housed in the exterior member.

According to the embodiments of the configurations 3 to 5, in a state where the electrode body 2 is housed in the exterior member 18, the electrode body 2 is held by being brought into contact with the step 182d, and it is possible to prevent the positional displacement of the electrode body 2 in the XY directions in the exterior member 18 due to vibration.

Configuration 6. In a state where the electrode body (2) is housed in the exterior member (18), a stack surface of an outermost layer of the electrode body (2) abuts on a region surface formed in the first region.

Configuration 7. The region surface formed in the first region (181) is parallel to a stack surface of an outermost layer of the electrode body (2).

According to the embodiments of the configurations 6 and 7, it is possible to prevent the positional displacement of the electrode body (2) in the Z direction in the exterior member (18) due to vibration.

Configuration 8. A method for manufacturing an all-solid-state battery, wherein the all-solid-state battery comprises:
an electrode body (2) in which a positive electrode layer (21,23), a solid electrolyte layer (25), and a negative electrode layer (22,24) are stacked; and
an exterior member (18) that houses the electrode body, wherein the exterior member (18) includes a first region (181) facing a stack surface of an outermost layer of the electrode body, and a second region (182) formed between the first region and a central portion of the electrode body in a stacking direction of the electrode body, the second region being provided with a displacement absorbing portion capable of absorbing displacement of the electrode body,
the manufacturing method comprising forming a plurality of steps in the displacement absorbing portion (182a-182d) by pressing a material of the exterior member (18).

According to this embodiment, it is possible to manufacture an all-solid-state battery in which, even when expansion and contraction of the electrode body 2 occur, the displacement absorbing portion is deformed following the displacement of the electrode body and absorbs the expansion and contraction, and thereby the displacement of the surface property of the exterior member and the displacement of the electrode body can be absorbed.

Configuration 9. In the forming of the plurality of steps, there are formed
a first step formed at a central portion in the stacking direction,
a second step formed in a direction away from the central portion in the stacking direction and formed inside as compared to the first step,
a third step formed in a direction away from the central portion in the stacking direction and formed inside as compared to the second step, and
a fourth step formed in a direction further away from the central portion in the stacking direction and formed inside as compared to the third step.

For example, when the third step is formed after the fourth step is first formed, a jig that does not deform the fourth step when the material of the exterior member 18 is pressed by the jig 303 is required. Similarly, when the second step is formed after the third step is formed, a jig that does not deform the third step and the fourth step when the material of the exterior member 18 is pressed by the jig 302 is required. Furthermore, when the first step is formed after the second step is formed, a jig that does not deform the second step, the third step, and the fourth step when the material of the exterior member 18 is pressed by the jig 301 is required. As described above, when a step (fourth step 182d) close to the second side surface of the electrode body is formed first and steps are sequentially formed in the direction away from the second side surface of the electrode body (third step, second step, and first step), a jig for preventing deformation of the formed step is separately required. According to this embodiment, by sequentially forming the first step, the second step, the third step, and the fourth step among the plurality of steps, the jig for preventing deformation of the formed step becomes unnecessary, and it is possible to provide a method for manufacturing the all-solid-state battery 1 having excellent work efficiency.

The invention is not limited to the foregoing embodiments, and various variations/changes are possible within the spirit of the invention.

What is claimed is:

1. An all-solid-state battery, comprising:
an electrode body in which a positive electrode layer, a solid electrolyte layer, and a negative electrode layer are stacked; and
an exterior member that houses the electrode body, wherein
the exterior member includes a first region facing a stack surface of an outermost layer of the electrode body, and a second region formed between the first region and a central portion of the electrode body in a stacking direction of the electrode body, and
the second region is provided with a displacement absorbing portion capable of absorbing displacement of the electrode body.

2. The all-solid-state battery according to claim 1, wherein a plurality of steps are formed in the displacement absorbing portion.

3. The all-solid-state battery according to claim 2, wherein the plurality of steps are formed at different inclination angles with respect to a normal line of a surface formed in the first region.

4. The all-solid-state battery according to claim 3, wherein among the plurality of steps, a step formed in a direction away from a central portion in the stacking direction is formed at an inclination angle smaller than an inclination angle of a step formed in the central portion.

5. The all-solid-state battery according to claim 3, wherein at least a part of a step formed at a position close to a surface of the electrode body among the plurality of steps abuts on a side surface of the electrode body housed in the exterior member.

6. The all-solid-state battery according to claim 1, wherein in a state where the electrode body is housed in the exterior member, a stack surface of an outermost layer of the electrode body abuts on a region surface formed in the first region.

7. The all-solid-state battery according to claim 6, wherein the region surface formed in the first region is parallel to a stack surface of an outermost layer of the electrode body.

8. A method for manufacturing an all-solid-state battery, wherein the all-solid-state battery comprises:
an electrode body in which a positive electrode layer, a solid electrolyte layer, and a negative electrode layer are stacked; and
an exterior member that houses the electrode body, wherein the exterior member includes a first region facing a stack surface of an outermost layer of the electrode body, and a second region formed between the first region and a central portion of the electrode body in a stacking direction of the electrode body, the second region being provided with a displacement absorbing portion capable of absorbing displacement of the electrode body,
the manufacturing method comprising forming a plurality of steps in the displacement absorbing portion by pressing a material of the exterior member.

9. The method for manufacturing the all-solid-state battery according to claim 8, wherein in the forming of the plurality of steps, there are formed
a first step formed at a central portion in the stacking direction,
a second step formed in a direction away from the central portion in the stacking direction and formed inside as compared to the first step,
a third step formed in a direction away from the central portion in the stacking direction and formed inside as compared to the second step, and
a fourth step formed in a direction further away from the central portion in the stacking direction and formed inside as compared to the third step.
